(19) United States
(12) Patent Application Publication
(10) Pub. No.: US 2020/0290098 A1
(43) Pub. Date: Sep. 17, 2020

(54) SYSTEMS AND METHODS FOR CLEANING A PRESSURIZED PIPE

(71) Applicant: Hydra-Stop LLC, Burr Ridge, IL (US)

(72) Inventors: Christopher C. Vazzana, Palos Park, IL (US); Andrew J. Nelson, Chicago, IL (US); Cullen Geppert, Chicago, IL (US)

(73) Assignee: Hydra-Stop LLC, Burr Ridge, IL (US)

(21) Appl. No.: 16/816,831

(22) Filed: Mar. 12, 2020

Related U.S. Application Data
(60) Provisional application No. 62/818,531, filed on Mar. 14, 2019.

(51) Int. Cl. B08B 9/045; B08B 9/043; B08B 9/035

(52) U.S. Cl. CPC B08B 9/045; B08B 9/0436; B08B 2209/04; B08B 2209/032; B08B 9/035

(57) ABSTRACT

Systems and methods are disclosed for cleaning an interior surface of a pressurized pipe. A conduit having a suction end disposed inside the pipe and a discharge end outside the pipe uses a pressure differential to create a suction flow through the pipe. A scrubber may be attached near the suction end to increase the amount of debris dislodged from the interior surface of the pipe.

### FIELD

The present disclosure generally relates to systems and methods for cleaning pressurized pipes.

### BACKGROUND

Pressurized conduits or pipes convey fluids, both liquid and gas, in municipalities, industrial plants, and commercial installations. When originally installed, a network of pipes typically includes strategically located isolation valves or block valves, which are used to isolate certain downstream sections of the pipe for repairs, relocation, and installation of new components into the pipe. When repair or maintenance of a pipe used in a municipal water system is required, however, inoperable isolation valves may need to be replaced, and the locations of existing isolation valves may necessitate the installation of additional isolation valves.

A hot tapping procedure may be used during pipe repair or maintenance to minimize service disruption. In a hot tapping procedure, a new access point into the pipe is formed while the fluid inside the pipe remains at an operable pressure. For example, commonly assigned U.S. Pat. Nos. 8,627,843 and 9,644,779 disclose methods of installing additional gate valves in pressurized pipes that do not require service interruption and result in minimal fluid or pressure loss. The additional gate valves connect to the pipe as an assembly using a permanent housing known as a valve housing that is sealably clamped, welded, or otherwise sealably joined to the pipe and normally extends upward. A temporary gate valve is sealably mounted on the open top of the valve housing (i.e., the distal end of the valve housing). One or more “tap” or installation housings and a tapping machine are mounted on top (distal end) of the temporary gate valve for delivering a cutting device through the temporary gate valve to the proximal end of the valve housing to cut a hole or “coupon” in the exposed pipe. After removal of the cutting device and closure of the temporary gate valve, the same or similar installation housings are mounted on the distal end of the temporary gate valve for delivering the gate valve cartridge through the temporary gate valve and to the interior of the valve housing, where it is housed while in the open position. This procedure is accomplished without depressurizing the pipe.

Instead of adding a gate valve to a pipe that may remain as a permanent fixture as disclosed in the '843 and '779 patents, sometimes all that is desired is to stop the flow through the pipe just upstream of a repair or maintenance location without installing a gate valve. In this case, a line stop is used to temporarily isolate the pipe at or upstream of the site of the repair or maintenance, while keeping the remainder of the system in operation. Similar to the '843 and '779 patents, commonly assigned U.S. Pat. No. 6,810,903 discloses a system that includes the use of a line stop fitting mounted to the pipe and a temporary gate valve mounted on top of the line stop fitting. Using appropriate housings and a tapping machine mounted on top of the temporary gate valve, a cutting device is inserted through the temporary gate valve to cut an opening in the pipe. After removal of the cutting device and closure of the temporary gate valve, a pump and ram with a housing are used to insert a line stop through the temporary gate valve and line stop fitting and into the pipe temporarily (see FIGS. 1-16 of the '903 patent) to stop the flow through the pipe. After a temporary line stop is withdrawn through the temporary gate valve, a completion plug is inserted through the temporary gate valve and into the line stop fitting to seal the line stop fitting so the temporary gate valve may be removed (see FIG. 16 of the '903 patent).

In addition to maintenance and repair, piping systems may require cleaning. Over time, projections or protuberances may build up on the inside surface of the pipe, known as tuberculation. In some cases, loosely adhered solids may build up in areas where fluid velocity is low. These conditions reduce the effective cross-sectional area of the pipe, thereby increasing pressure drop through the pipe and reducing efficiency of the pipe system. Cleaning the pipe not only reduces the pressure drop and increases efficiency, but also can reduce or eliminate particulates, biofilms, and silt that may travel to the end user during system perturbations or maintenance, which may result in cloudy or smelly water. Current pipe cleaning systems and methods are performed on portions of the pipe system that have been shut down and drained, which is costly, labor intensive, and requires installation of bypass lines to provide fluid to the end user during cleaning. Other pipe cleaning methods are known in which the pressure in the pipe is reduced below the normal operating pressure, but also interrupt service to the end user during cleaning.

### SUMMARY

In accordance with one aspect of the present disclosure, a system for cleaning an interior surface of a pressurized pipe includes an auxiliary housing coupled to the pressurized pipe, and a conduit extending though a conduit port formed in the auxiliary housing, the conduit including a suction end disposed inside the pressurized pipe and a discharge end disposed in a surrounding environment outside of the pipe.

In accordance with another aspect of the present disclosure, a method of cleaning an interior surface of a pressurized pipe includes placing a suction end of a conduit inside the pressurized pipe, with a discharge end of the conduit located in a surrounding environment outside of the pipe, wherein the surrounding environment has an ambient pressure that is less than a fluid pressure inside the pipe, and generating a suction flow through the conduit from the suction end to the discharge end by using a pressure differential between the ambient pressure and the fluid pressure.

In accordance with a further aspect of the present disclosure, a system for cleaning an interior surface of a pressurized pipe includes an auxiliary housing coupled to the pressurized pipe, a conduit extending though a conduit port formed in the auxiliary housing, the conduit including a suction end disposed inside the pressurized pipe and a discharge end disposed in a surrounding environment outside of the pipe, wherein the surrounding environment has an ambient pressure that is less than a fluid pressure inside the pipe to create a pressure differential causing a suction flow through the conduit from the suction end to the discharge end, a reel disposed in the auxiliary housing, wherein an intermediate section of the conduit is coiled around the reel, and a guide coupled to the conduit near the suction end of the pipe.

The features, functions, and advantages that have been discussed can be achieved independently in various embodiments or may be combined in yet other embodiments further details of which can be seen with reference to the following description and drawings.

### BRIEF DESCRIPTION OF THE DRAWINGS

FIG. 1 is a side elevation view, in cross-section, of a system for cleaning an interior surface of a pipe under pressure, according to the present disclosure.

FIG. 2 is an enlarged detail view of a pipe cleaning system having a scrubber.

FIG. 3 is a side elevation view, in partial cross-section, of an alternative embodiment of a system for cleaning an interior surface of a pipe under pressure, according to the present disclosure.

It should be understood that the drawings are not necessarily drawn to scale and that the disclosed embodiments are sometimes illustrated schematically. It is to be further appreciated that the following detailed description is merely exemplary in nature and is not intended to limit the invention or the application and uses thereof. Hence, although the present disclosure is, for convenience of explanation, depicted and described as certain illustrative embodiments, it will be appreciated that it can be implemented in various other types of embodiments and in various other systems and environments.

### DETAILED DESCRIPTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

This disclosure relates to systems and methods for cleaning an interior surface of a pipe while maintained at normal operating pressure. More specifically, solids loosely adhered to an interior surface of the pipe are removed, in part, by using the differential between the pressure inside the pipe and the ambient pressure in the environment surrounding the pipe to provide suction to a tool deployed within the pipe.

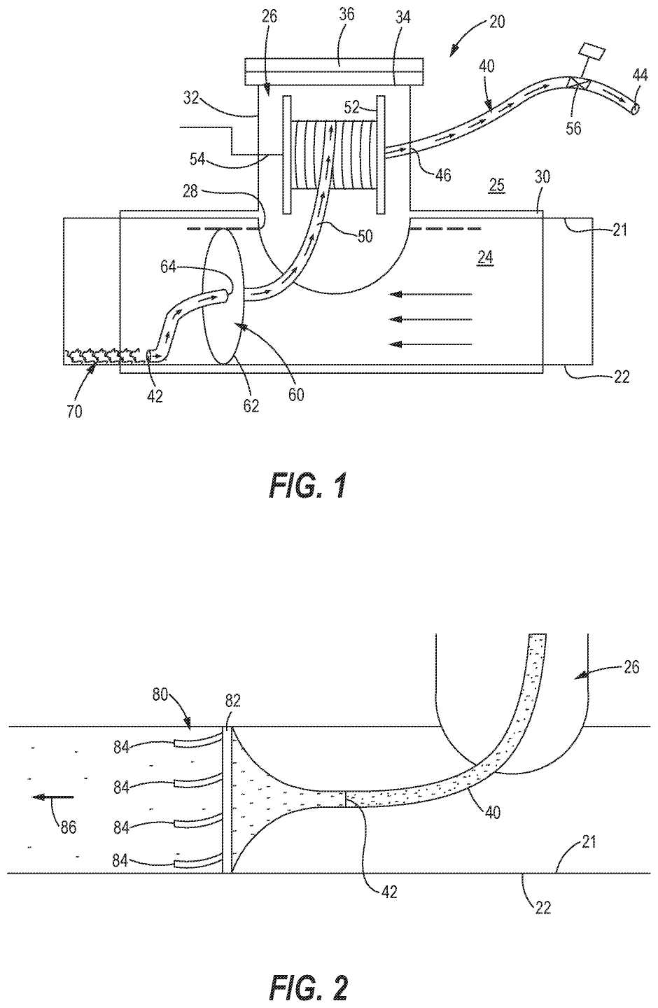

FIG. 1 illustrates a system 20 for cleaning an interior surface 21 of a pipe 22 containing a fluid 24 disposed at an operating pressure above an ambient pressure present in the surrounding environment 25 outside of the pipe 22. A hot tapping procedure, such as described in the '843, and '779 patents cited above, may be performed on the pressurized pipe 22, during which an auxiliary housing 26 is coupled to the pipe 22 and an access port 28 is cut into the pipe 22. The auxiliary housing 26 includes a base 30 attached to an exterior surface of the pipe 22 and a housing section 32. An end 34 of the auxiliary housing 26 is closed off by a top plate 36. Prior to attaching the top plate 36, the system 20 may be disposed in the housing section 32.

The system 20 includes a conduit 40 having a suction end 42 and a discharge end 44. The conduit 40 extends through a conduit port 46 formed in the auxiliary housing 26, so that the suction end 42 is disposed inside the pressurized pipe 22 while the discharge end 44 is disposed in the surrounding environment 25 outside of the pipe 22. An intermediate section 50 of the conduit 40 may be coiled around a reel 52. A shaft 54 is coupled to and rotates with the reel 52. The shaft 54 extends outside of the auxiliary housing 26. Rotation of the shaft 54, by mechanical, electrical, or other means, causes rotation of the reel 52 to increase or decrease the distance between the suction end 42 and discharge end 44 of the conduit 40. A valve 56 may be provided near the discharge end 44 to control operation of the system 20, as described more fully below.

A guide 60 is coupled to the conduit 40 to help position the suction end 42 of the conduit 40 adjacent the interior surface 21 of the pipe 22. In the illustrated embodiment, the guide 60 includes an outer edge 62 sized to slidably engage the interior surface 21 of the pipe 22, and an inner orifice 64 coupled to the conduit 40 near the suction end 42. The guide 60 is attached to a point on the conduit 40 to leave a length of conduit that is sufficient for the suction end 42 to be placed adjacent the interior surface 21 of the pipe 22.

In operation, the guide 60 is positioned inside the pipe 22 and advanced along the pipe 22 to a location along the interior surface 21 having loosely adhered debris 70. In some embodiments, movement of the guide 60 is passive, where the guide 60 follows the direction of fluid flow through the pipe 22. For systems using passive positioning, the guide 60 may have a shape that is highly responsive to the fluid flow, such as the parachute shape shown in FIG. 1. Alternatively, positioning of the guide 60 within the pipe may be active, as may be needed in low flow areas of the pipe or portions of pipe located upstream of the auxiliary housing 26. For active positioning, the suction end 42 of the conduit 40 may be carried by a remotely operated vehicle. Once in position, the valve 56 may be opened so that the pressure differential between the higher operating pressure inside the pipe 22 and the lower ambient pressure in the surrounding environment 25 generates a suction flow through the conduit 40. The suction flow dislodges the debris 70, carries the debris 70 through the conduit 40, and discharges the debris 70 from the discharge end 44 of the conduit 40.

In some embodiments, the guide 60 may include a scrubber to improve the cleaning efficiency of the system 20. In the embodiment shown in FIG. 2, a mechanical scrubber 80 is attached to the guide 60. The mechanical scrubber 80 includes a base ring 82 rotatably coupled to the guide 60. Scrubber arms 84 extend from the base ring 82 and are configured to engage the interior surface 21 of the pipe 22. The scrubber arms 84 further may be shaped so that a fluid flow 86 through the pipe 22 creates a force on the arms 84 that causes the base ring 82 to rotate relative to the guide 60. In this embodiment, the guide 60 is formed as a funnel attached to the suction end 42 of the conduit 40, so that debris 70 dislodged by the scrubber arms 84 is caught by the guide 60 and directed into the conduit 40. While a mechanical scrubber 80 is shown, it will be appreciated that the scrubber may generate sonic, pneumatic, or hydraulic forces that dislodge the debris 70.

Once a cleaning operation is complete, the valve 56 may be closed to stop suction flow through the conduit 40. The conduit 40, reel 52, and guide 60 may then be removed from the pipe 22 through the auxiliary housing 26 while the fluid 24 is maintained at the operating pressure, thereby continuously providing service to the end user.

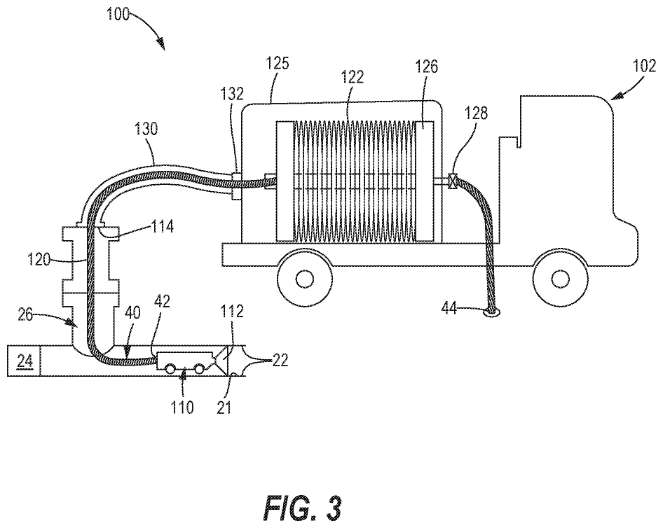

FIG. 3 illustrates an alternative embodiment of a system 100 for cleaning the interior surface 21 of the pipe 22 containing the fluid 24 disposed at an operating pressure above an ambient pressure present in the surrounding environment 25 outside of the pipe 22. In this embodiment, the system 100 includes an exterior conduit management system 102 that is positioned outside of the pipe 22 but maintains the conduit 40 at an elevated pressure.

In this embodiment, the suction end 42 of the conduit is 40 carried by a probe 110. The probe 110 may include a guide 112 in fluid communication with the suction end 42 of the conduit 40 and configured to engage the interior surface 21 of the pipe 22. The conduit 40 extends through a conduit port 114 formed in the auxiliary housing 26. An intermediate section 120 of the conduit 40 extends from the probe 110 to the exterior conduit management system 102. A further length of conduit 122 is coiled around a reel 124 provided within a pressurized housing 125 of the exterior conduit management system 102. The exterior conduit management system 102 may be a stationary system, or it may be provided on a vehicle as shown in FIG. 3. The discharge end 44 of the conduit 40 is positioned adjacent an existing drain 126, and may include a valve 128 for selectively controlling fluid flow through the discharge end 44.

The exterior conduit management system 102 further includes an outer sheath 130 surrounding a portion of the intermediate section 120 of the conduit 40. More specifically, the sheath 130 extends from a coupling 132 on the pressurized housing 125 to a sealed connection with the auxiliary housing 26. The outer sheath 130, therefore, is exposed to the pressure of the fluid 24 within the pipe 22. That fluid is communicated through the outer sheath 130 to the pressurized housing 125, thereby placing the reel 124 under the same pressure that is present within the pipe 22. In operation, the pressure differential between the conduit suction end 42 (being at the elevated pressure of the fluid) and the conduit discharge end 44 (being at the lower, ambient pressure of the surrounding environment) generates a suction flow through the conduit 40.

All references, including publications, patent applications, and patents, cited herein are hereby incorporated by reference. All methods described herein can be performed in any suitable order unless otherwise indicated herein or otherwise clearly contradicted by context. The use of any and all examples, or exemplary language (e.g., “such as”) provided herein, is intended to illuminate the disclosed subject matter and does not pose a limitation on the scope of the claims. Any statement herein as to the nature or benefits of the exemplary embodiments is not intended to be limiting, and the appended claims should not be deemed to be limited by such statements. More generally, no language in the specification should be construed as indicating any non-claimed element as being essential to the practice of the claimed subject matter. The scope of the claims includes all modifications and equivalents of the subject matter recited therein as permitted by applicable law. Moreover, any combination of the above-described elements in all possible variations thereof is encompassed by the claims unless otherwise indicated herein or otherwise clearly contradicted by context. Additionally, aspects of the different embodiments can be combined with or substituted for one another. Finally, the description herein of any reference or patent, even if identified as “prior,” is not intended to constitute a concession that such reference or patent is available as prior art against the present disclosure.

What is claimed is:

1. A system for cleaning an interior surface of a pressurized pipe, the system comprising:
an auxiliary housing coupled to the pressurized pipe; and
a conduit extending though a conduit port formed in the auxiliary housing, the conduit including a suction end disposed inside the pressurized pipe and a discharge end disposed in a surrounding environment outside of the pipe, wherein the surrounding environment has an ambient pressure that is less than a fluid pressure inside the pipe to create a pressure differential causing a suction flow through the conduit from the suction end to the discharge end.

2. The system of claim 1, further including a guide coupled to the conduit near the suction end of the pipe.

3. The system of claim 2, in which the guide includes an outer edge sized to slidably engage the interior surface of the pipe, and an inner orifice coupled to the conduit near the suction end.

4. The system of claim 3, in which the guide is attached to a point on the conduit to leave a length of conduit sufficient for the suction end to be placed adjacent the interior surface of the pipe.

5. The system of claim 4, in which the guide has a funnel shape.

6. The system of claim 5, further comprising a scrubber coupled to the guide.

7. The system of claim 6, in which the scrubber includes a base ring rotatably coupled to the guide and scrubber arms extending from the base ring and configured to engage the interior surface of the pipe.

8. The system of claim 7, in which the scrubber arms are shaped so that a fluid flow through the pipe creates a force on the arms causing the base ring to rotate relative to the guide.

9. The system of claim 1, further comprising a reel disposed in the auxiliary housing, wherein an intermediate section of the conduit is coiled around the reel.

10. The system of claim 9, further comprising a shaft coupled to and rotatable with the reel and having a shaft free end disposed outside of the auxiliary housing.

11. The system of claim 1, further comprising a valve disposed in the conduit and operable between a closed position and an open position.

12. The system of claim 1, further comprising an exterior conduit management system having a pressurized housing fluidly coupled to the pipe by an outer sheath, wherein an intermediate portion of the conduit extends from the pipe, through the outer sheath, and into the pressurized housing.

13. The system of claim 12, in which the exterior conduit management system further includes a reel, and in which the conduit is partially wound around the reel.

14. A method of cleaning an interior surface of a pressurized pipe, the method comprising:
placing a suction end of a conduit inside the pressurized pipe, with a discharge end of the conduit located in a surrounding environment outside of the pipe, wherein the surrounding environment has an ambient pressure that is less than a fluid pressure inside the pipe; and
generating a suction flow through the conduit from the suction end to the discharge end by using a pressure differential between the ambient pressure and the fluid pressure.

15. The method of claim 14, in which a guide is coupled near the suction end of the conduit, the guide having an outer edge sized to slidably engage the interior surface of the pipe and an inner orifice coupled to the conduit.

16. The method of claim 15, further comprising engaging an interior surface of the pipe with scrubber arms rotatably coupled to the guide.

17. A system for cleaning an interior surface of a pressurized pipe, the system comprising:
an auxiliary housing coupled to the pressurized pipe;
a conduit extending though a conduit port formed in the auxiliary housing, the conduit including a suction end disposed inside the pressurized pipe and a discharge end disposed in a surrounding environment outside of the pipe, wherein the surrounding environment has an ambient pressure that is less than a fluid pressure inside the pipe to create a pressure differential causing a suction flow through the conduit from the suction end to the discharge end;
a reel disposed in the auxiliary housing, wherein an intermediate section of the conduit is coiled around the reel; and
a guide coupled to the conduit near the suction end of the pipe.

18. The system of claim 17, in which the guide has a funnel shape and includes an outer edge sized to slidably engage the interior surface of the pipe, and an inner orifice coupled to the conduit near the suction end.

19. The system of claim 18, further comprising a scrubber including a base ring rotatably coupled to the guide and scrubber arms extending from the base ring and configured to engage the interior surface of the pipe.

20. The system of claim 17, further comprising a valve disposed in the conduit and operable between a closed position and an open position.
